(19) United States
(12) Patent Application Publication
(10) Pub. No.: US 2023/0187755 A1
(43) Pub. Date: Jun. 15, 2023

(54) BATTERY PACK, AND MANUFACTURING DEVICE AND MANUFACTURING METHOD FOR BATTERY PACK

(71) Applicant: LG ENERGY SOLUTION, LTD., Seoul (KR)

(72) Inventors: Kwang-Keun OH, Daejeon (KR); Jin-Oh YANG, Daejeon (KR); In-Hyuk JUNG, Daejeon (KR); Hae-Won CHOI, Daejeon (KR)

(73) Assignee: LG ENERGY SOLUTION, LTD., Seoul (KR)

(21) Appl. No.: 17/921,041

(22) PCT Filed: Jan. 11, 2022
(86) PCT No.: PCT/KR2022/000503

§ 371 Date: Oct. 24, 2022

(30) Foreign Application Priority Data
Jan. 11, 2021 (KR) 10-2021-0003549

(51) Int. Cl. H01M 50/249; H01M 50/627; H01M 50/417

(52) U.S. Cl. CPC H01M 50/249; H01M 50/627; H01M 50/417

(57) ABSTRACT

A battery pack according to an embodiment of the present disclosure includes a plurality of battery cells, and a pack case in which the plurality of battery cells are accommodated, wherein the pack case includes a potting resin which covers all sides of the plurality of battery cells and is filled to a predetermined height between the plurality of battery cells.

### TECHNICAL FIELD

The present disclosure relates to a battery pack and an apparatus and method for manufacturing the battery pack.

The present application claims the benefit of Korean Patent Application No. 10-2021-0003549 filed on Jan. 11, 2021 with the Korean Intellectual Property Office, the disclosure of which is incorporated herein by reference in its entirety.

### BACKGROUND ART

Due to their characteristics of being easily applicable to various products and electrical properties such as a high energy density, secondary batteries are not only commonly applied to portable devices, but universally applied to electric vehicles (EVs) or hybrid electric vehicle (HEVs) that are driven by an electrical driving source. Such secondary batteries are gaining attention for their primary advantage of remarkably reducing the use of fossil fuels and not generating by-products from the use of energy, making it a new eco-friendly and energy efficient source of energy.

The types of secondary batteries widely used at present include lithium ion batteries, lithium polymer batteries, nickel cadmium batteries, nickel hydrogen batteries, nickel zinc batteries or the like. This unit secondary battery cell, i.e., a unit battery cell has an operating voltage of about 2.5V to 4.5V. Accordingly, when a higher output voltage is required, a plurality of battery cells may be connected in series to form a battery pack. Additionally, the battery pack may be fabricated by connecting the plurality of battery cells in parallel according to the charge/discharge capacity required for the battery pack. Accordingly, the number of battery cells included in the battery pack may be variously set depending on the required output voltage or charge/discharge capacity.

Meanwhile, when fabricating the battery pack by connecting the plurality of battery cells in series/in parallel, it is general to make a battery module including at least one battery cell, and then fabricate a battery pack or a battery rack using at least one battery module with an addition of any other component.

The conventional battery pack includes a pack case to support and fix the plurality of battery cells. In general, the conventional pack case includes an assembly of a plurality of frame members including a front frame member, a rear frame member, a side frame member, an upper frame member and a lower frame member.

Accordingly, the conventional battery pack has increases in manufacturing cost and process complexity due to the pack case structure including the assembly of the plurality of frame members.

Therefore, in the manufacture of the pack case of the battery pack, there is a need for an approach to achieve price competitiveness and reduce the manufacturing process cost.

### DISCLOSURE

### Technical Problem

The present disclosure is directed to providing a battery pack with price competitiveness and reduced manufacturing cost, and an apparatus and method for manufacturing the battery pack.

### Technical Solution

To solve the above-described problem, the present disclosure provides a battery pack including a plurality of battery cells, and a pack case to accommodate the plurality of battery cells, wherein the pack case includes a potting resin which covers all sides of the plurality of battery cells and is filled to a predetermined height between the plurality of battery cells.

The plurality of battery cells may be positioned such that they are inserted into the potting resin, with upper and lower ends exposed at least in part.

An upper surface of the potting resin may be disposed at a lower position by a predetermined height than the upper end of the plurality of battery cells in a heightwise direction of the plurality of battery cells, and a lower surface of the potting resin may be disposed at a higher position by a predetermined height than the lower end of the plurality of battery cells in the heightwise direction of the plurality of battery cells.

The potting resin may include silicone resin.

Additionally, the present disclosure provides an apparatus for manufacturing a battery pack including a resin injection frame having an accommodation space for accommodating a plurality of battery cells to inject a resin for covering the plurality of battery cells, a resin injection port provided on a side of the resin injection frame to inject the resin into the accommodation space, and an air outlet spaced apart from the resin injection port, the air outlet through which air inside the accommodation space is forced out when injecting the resin.

The resin injection frame may be separated from the plurality of battery cells and the cured resin when the cure of the resin injected into the accommodation space is completed.

The resin injection frame may include a lower frame which covers a bottom of the plurality of battery cells, an upper frame disposed opposite the lower frame to cover a top of the plurality of battery cells, and a side frame detachably connected to the lower frame and the upper frame, wherein the side frame covers sides of the plurality of battery cells.

The resin injection port and the air outlet may be provided in the side frame.

The resin may be injected in a room temperature thin state.

The resin may include silicone resin.

Furthermore, the present disclosure provides a method for manufacturing a battery pack including placing a plurality of battery cells in an accommodation space of a resin injection frame, injecting a resin for covering the plurality of battery cells into the accommodation space of the resin injection frame, and separating the resin injection frame from the plurality of battery cells and the cured resin when the cure of the resin injected into the accommodation space is completed.

The resin may be injected into the accommodation space through a resin injection port provided in the resin injection frame.

The resin may be injected in a room temperature thin state.

The resin injection frame may include a lower frame which cover a bottom of the plurality of battery cells, an upper frame disposed opposite the lower frame to cover a top of the plurality of battery cells, and a side frame detachably connected to the lower frame and the upper frame, wherein the side frame covers sides of the plurality of battery cells.

The resin injection frame may have an air outlet spaced apart from the resin injection port, the air outlet through which air inside the accommodation space is forced out when injecting the resin.

### Advantageous Effects

According to the various embodiments as described above, it is possible to provide a battery pack with price competitiveness and reduced manufacturing cost, and an apparatus and method for manufacturing the battery pack.

### DESCRIPTION OF DRAWINGS

The accompanying drawings illustrate a preferred embodiment of the present disclosure, and together with the detailed description of the present disclosure described below, serve to provide a further understanding of the technical aspects of the present disclosure, and thus the present disclosure should not be construed as being limited to the drawings.

FIG. 1 is a diagram illustrating a battery pack according to an embodiment of the present disclosure.

FIG. 2 is a diagram illustrating an apparatus for manufacturing the battery pack of FIG. 1.

FIG. 3 is an exploded perspective view of the apparatus for manufacturing a battery pack of FIG. 2.

FIGS. 4 to 9 are diagrams illustrating a method for manufacturing a battery pack through the apparatus for manufacturing a battery pack of FIG. 2.

FIG. 10 is a flowchart illustrating a method for manufacturing the battery pack of FIG. 1.

FIG. 11 is a diagram illustrating a vehicle including a battery pack according to an embodiment of the present disclosure.

### BEST MODE

The present disclosure will become apparent by describing a preferred embodiment of the present disclosure in detail with reference to the accompanying drawings. The embodiment described herein is provided by way of illustration to help an understanding of the present disclosure, and it should be understood that various modifications may be made to the present disclosure in any other embodiment than the embodiment described herein. Additionally, to help an understanding of the present disclosure, the accompanying drawings are not shown in true scale and may depict some exaggerated elements.

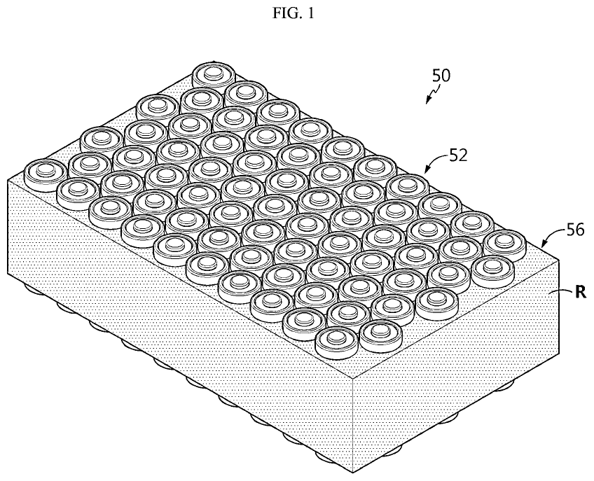

FIG. 1 is a diagram illustrating a battery pack according to an embodiment of the present disclosure.

Referring to FIG. 1, the battery pack 50 includes a plurality of battery cells 52 and a pack case 56 for accommodating the plurality of battery cells, and the pack case 56 may include a potting resin R that covers all the sides of the plurality of battery cells 52, and is filled to a predetermined height between the plurality of battery cells 52.

The plurality of battery cells 52 may include secondary batteries, for example, cylindrical secondary batteries, pouch type secondary batteries or prismatic secondary batteries. Hereinafter, in this embodiment, a description is made based on cylindrical secondary batteries as the plurality of battery cells 52.

The plurality of battery cells 52 may be positioned such that they are inserted into the potting resin R, with the upper and lower ends exposed at least in part.

The plurality of battery cells 52 may have a structure of mounting a busbar member for electrical connection or connecting to any other component at the partially exposed upper and lower ends.

To this end, in the pack case 56, the upper surface of the potting resin R may be disposed at a lower position by a predetermined height than the upper end of the plurality of battery cells 52 in the heightwise direction of the plurality of battery cells 52, and the lower surface of the potting resin R may be disposed at a higher position by a predetermined height than the lower end of the plurality of battery cells 52 in the heightwise direction of the plurality of battery cells 52.

The potting resin R may include materials having high heat resistance, electrical insulating properties, weather resistance and water repellency. For example, the potting resin R may include silicone resins.

As described above, in this embodiment, since the pack case 56 includes the potting resin R filled between the battery cells 52 to fully cover the battery cells 52, it is possible to provide the battery pack 50 having a slimmer and simpler structure and a price competitiveness advantage in price compared to the conventional pack case structure including an assembly of a plurality of frame members.

Additionally, in this embodiment, it is possible to uniformly dissipate heat generated from the battery cells 52 through the pack case 56 made of the potting resin R filled between the battery cells 52 to fully cover the battery cells 52, thereby significantly increasing the heat dissipation efficiency of the battery cells 52.

Accordingly, in this embodiment, it is possible to significantly increase the cooling performance of the battery cells 52 through the pack case 56 including the potting resin R.

Hereinafter, a battery pack manufacturing apparatus and method for manufacturing the pack case 56 of the battery pack 50 according to this embodiment will be described in more detail.

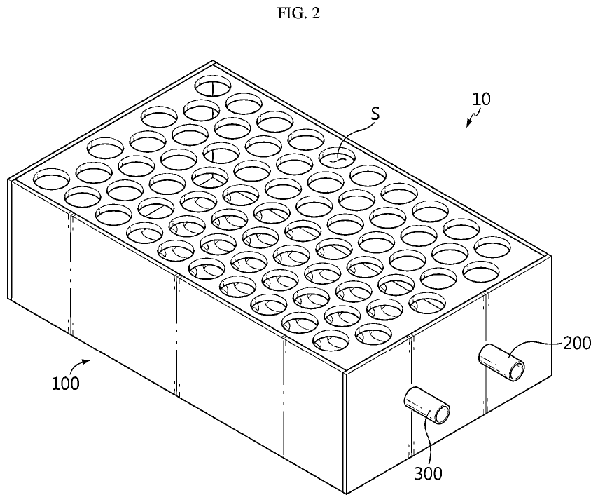

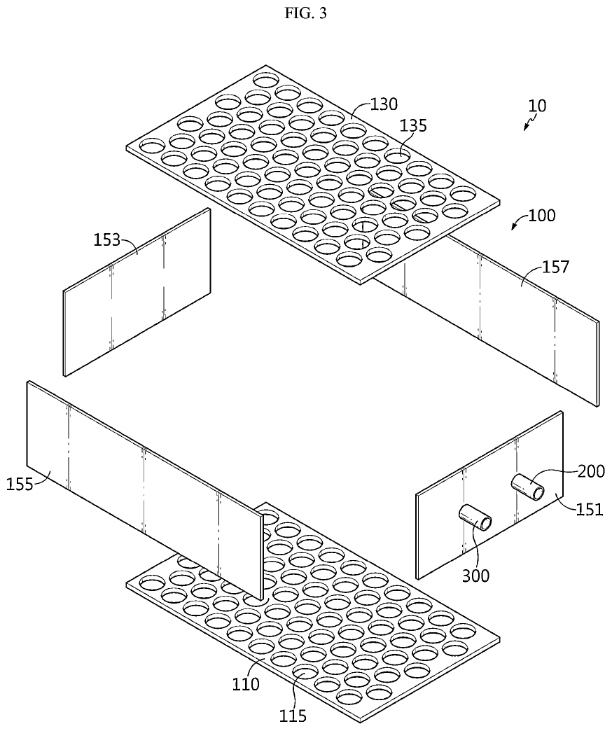

FIG. 2 is a diagram illustrating an apparatus for manufacturing the battery pack of FIG. 1, and FIG. 3 is an exploded perspective view of the apparatus for manufacturing a battery pack of FIG. 2.

Referring to FIGS. 2 and 3, the apparatus 10 for manufacturing a battery pack may manufacture the pack case 56 (see FIG. 1) for supporting and fixing the plurality of battery cells 52 (see FIG. 1) of the battery pack 50 (see FIG. 1).

The apparatus 10 for manufacturing a battery pack may include a resin injection frame 100, a resin injection port 200 and an air outlet 300.

The resin injection frame 100 may have an accommodation space S that accommodates the plurality of battery cells 52 to inject a resin R (see FIG. 1) for covering the plurality of battery cells 52.

When the cure of the resin R (see FIG. 1) injected into the accommodation space S is completed, the resin injection frame 100 may be separated from the plurality of battery cells 52 and the cured resin R (see FIG. 1).

The resin injection frame 100 may include a lower frame 110, an upper frame 130 a side frame 150.

The lower frame 110 is used to cover the bottom of the plurality of battery cells 52, and may support the plurality of battery cells 52. To this end, the lower frame 110 may have a size that is large enough to cover the bottom of the plurality of battery cells 52.

The lower frame 110 may have a cell insertion hole 115.

The cell insertion hole 115 is where the bottom of the plurality of battery cells 52 are inserted, and a plurality of cell insertion holes 115 may be provided. The number of cell insertion holes 115 corresponding to the number of battery cells 52 may be provided.

The upper frame 130 may be disposed opposite the lower frame 110, and may cover the top of the plurality of battery cells 52. To this end, the upper frame 130 may have a size that is large enough to cover the top of the plurality of battery cells 52.

The upper frame 130 may have a cell insertion hole 135.

The cell insertion hole 135 is where the upper part of the plurality of battery cells 52 are inserted, and a plurality of cell insertion holes 135 may be provided. The number of cell insertion holes 135 corresponding to the number of battery cells 52 may be provided.

The side frame 150 may be detachably connected to the lower frame 110 and the upper frame 130, and may be formed to cover the sides of the plurality of battery cells 52.

The side frame 150 may include a first side plate 151, a second side plate 153, a third side plate 155 and a fourth side plate 157.

The first side plate 151 may cover at least one side of the plurality of battery cells 52. Specifically, the first side plate 151 may cover the right side of the plurality of battery cells 52. The first side plate 151 may include the resin injection port 200 and the air outlet 300 as described below.

The second side plate 153 may be disposed opposite the first side plate 151, and may cover at least one other side of the plurality of battery cells 52. Specifically, the second side plate 153 may cover the left side of the plurality of battery cells 52.

The third side plate 155 may cover the front side of the plurality of battery cells 52. The third side plate 155 may be detachably coupled to the first side plate 151 and the second side plate 153

The fourth side plate 157 may be disposed opposite the third side plate 155, and may cover the rear side of the plurality of battery cells 52. The fourth side plate 157 may be detachably coupled to the first side plate 151 and the second side plate 153

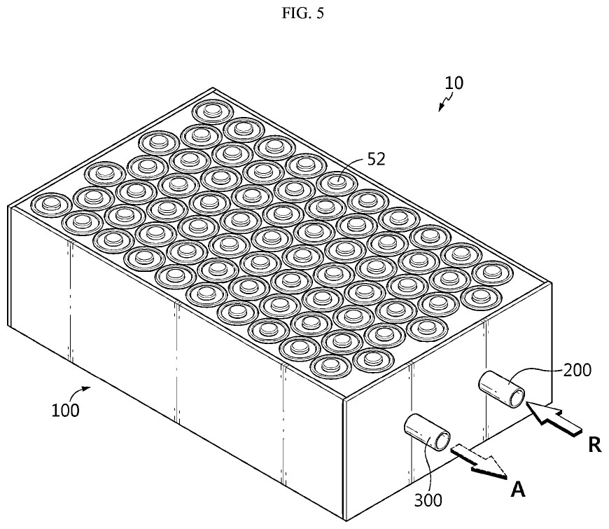

The resin injection port 200 may be used to inject the resin R (see FIG. 5) into the accommodation space S. The resin R may be injected into the accommodation space S through the resin injection port 200 in a room temperature thin state. In this embodiment, since the resin R is injected in room temperature state, it is possible to prevent thermal damage of the plurality of battery cells 52 caused by the injection of the resin R, compared to when the resin R is injected in heated state.

The resin injection port 200 may be provided on one side of the resin injection frame 100. Specifically, the resin injection port 200 may be provided in the side frame 150. More specifically, the resin injection port 200 may be provided in the first side plate 151 of the side frame 150.

The air outlet 300 is used to force air A (see FIG. 5) inside the accommodation space out when injecting the resin R (see FIG. 5), and may be spaced apart from the resin injection port 200.

In this embodiment, since air A inside the accommodation space S is forced out through the air outlet 300 when injecting the resin R, the resin R may be injected into the accommodation space S more uniformly and cured in the accommodation space S more uniformly.

Specifically, the air outlet 300 may be provided in the side frame 150. More specifically, the air outlet 300 may be provided in the first side plate 151 of the side frame 150.

Hereinafter, a method for manufacturing the pack case 56 of the battery pack 50 through the apparatus 10 for manufacturing a battery pack according to an embodiment of the present disclosure will be described in more detail.

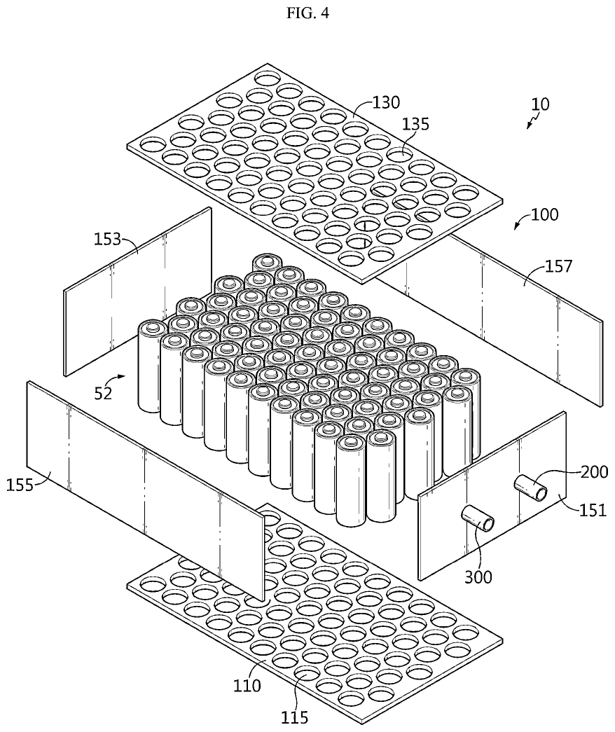

FIGS. 4 to 9 are diagrams illustrating a method for manufacturing a battery pack through the apparatus for manufacturing a battery pack of FIG. 2.

Referring to FIG. 4, a manufacturer may place the plurality of battery cells 52 in the resin injection frame 100 when manufacturing the pack case of the battery pack. Specifically, the manufacturer may cover the plurality of battery cells 52 with the lower frame 110, the upper frame 130 and the side frame 150 of the resin injection frame 100 and couple the lower frame 110, the upper frame 130 and the side frame 150 one another. Accordingly, the accommodation space S (see FIG. 3) may be formed in the resin injection frame 100, and the plurality of battery cells 52 may be accommodated in the accommodation space S.

Referring to FIG. 5, the manufacturer may inject the resin R into the accommodation space S (see FIG. 2) in the resin injection frame 100 through the resin injection port 200. Here, the resin R may be injected in a room temperature thin state to prevent thermal damage of the plurality of battery cells 52. Additionally, air in the accommodation space S may be released from the resin injection frame 100 through the air outlet 300 to increase the injection efficiency of the resin R.

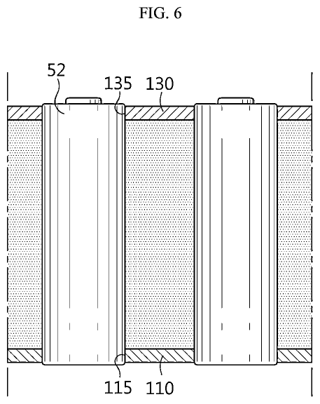

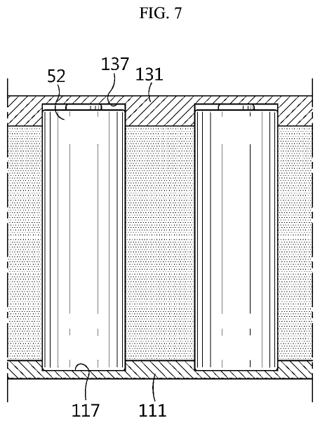

Referring to FIG. 6, when injecting the resin R (see FIG. 5), the plurality of battery cells 52 may be fixed when inserted into the cell insertion hole 115 of the lower frame 110 and the cell insertion hole 135 of the upper frame 130. The fixing structure of the plurality of battery cells 52 is not limited thereto, and the plurality of battery cells 52 may be fixed in any other manner. For example, referring to FIG. 7, the plurality of battery cells 52 may be fixed when inserted into a cell insertion groove 117 provided with a groove structure of a predetermined depth in a lower frame 111 and a cell insertion groove 137 provided with a groove structure of a predetermined depth in an upper frame 131.

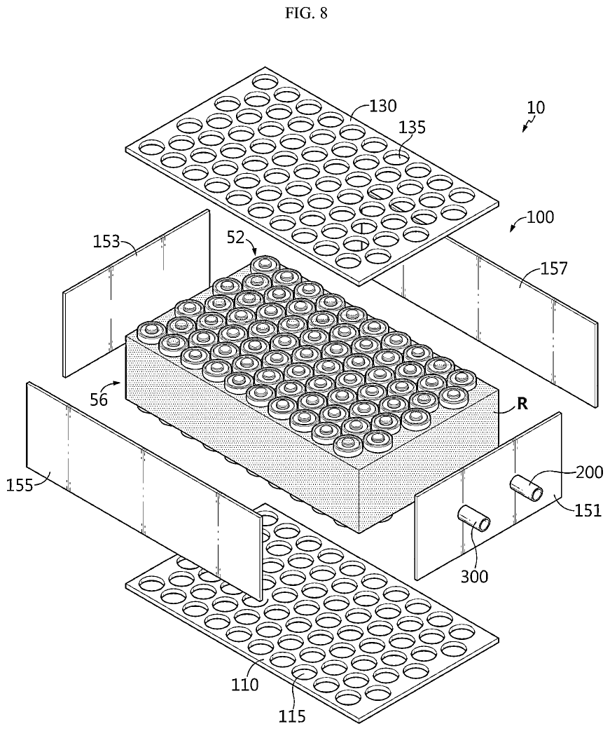

Referring to FIG. 8, when the injected resin R is cured, the manufacturer may separate the resin injection frame 100 from the resin R and the plurality of battery cells 52. Specifically, the manufacturer may separate the lower frame 110, the upper frame 130 and the side frame 150 from the resin R and the plurality of battery cells 52 by disconnecting the connection of the lower frame 110, the upper frame 130 and the side frame 150 of the resin injection frame 100.

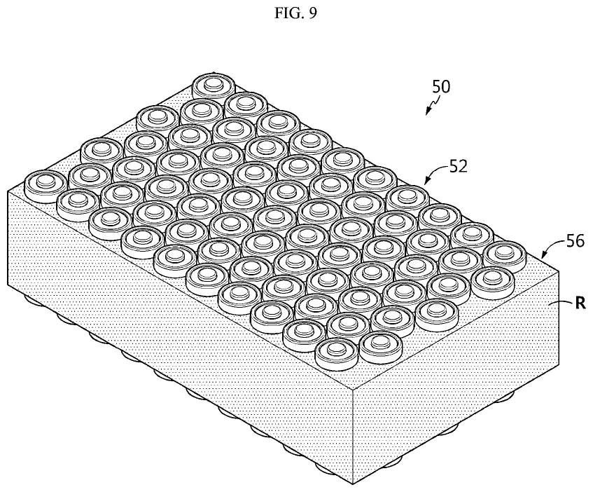

Referring to FIG. 9, the battery pack 50 may include the pack case 56 including the resin R through the manufacturing apparatus 10 (see FIG. 5). The pack case 56 including the potting resin may be a so-called cell-potting resin structure. In this embodiment, it is possible to ensure the insulating properties and mechanical strength through the pack case 56 including the resin R.

In this embodiment, it is possible to manufacture the pack case 56 of the battery pack 50 in a more straightforward and efficient manner than the conventional pack case structure including a plurality of frame members, through the pack case 56 of the cell-potting resin structure.

Accordingly, in this embodiment, it is possible to significantly reduce the manufacturing cost of the pack case 56 of the battery pack 50, and simplify the manufacturing process in a more straightforward and efficient manner through the apparatus 10 for manufacturing a battery pack.

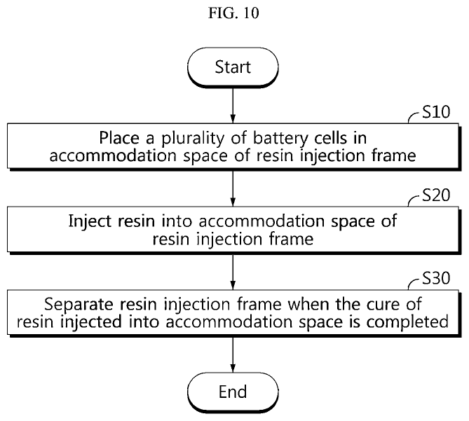

FIG. 10 is a flowchart illustrating a method for manufacturing the battery pack of FIG. 1.

Referring to FIG. 10, in the manufacture of the pack case of the battery pack, the manufacturer may place the plurality of battery cells in the accommodation space of the resin injection frame (S10). When the placement of the plurality of battery cells is completed, the manufacturer may inject a resin for covering the plurality of battery cells into the accommodation space of the resin injection frame (S20).

Here, the resin may be injected into the accommodation space through the resin injection port provided in the resin injection frame, and may be injected in room temperature state to prevent thermal damage of the plurality of battery cells. When injecting the resin, air in the accommodation space may be released from the resin injection frame through the air outlet.

When the cure of the resin injected into the accommodation space is completed, the resin injection frame may be separated from the plurality of battery cells and the cured resin (S30). The cured resin may act as a pack case to accommodate and cover the plurality of battery cells.

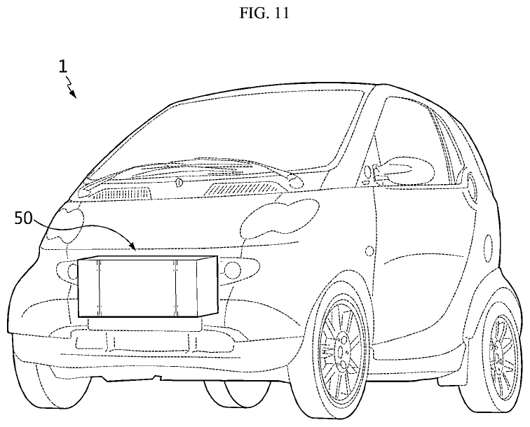

FIG. 11 is a diagram illustrating a vehicle including the battery pack according to an embodiment of the present disclosure.

Referring to FIG. 11, the battery pack 50 may be provided in the vehicle 1 as a fuel source of the vehicle. For example, the battery pack 50 may be provided in the vehicle 1 such as an electric vehicle, a hybrid electric vehicle and any other application using the battery pack 50 as a fuel source.

Additionally, in addition to the vehicle 1, the battery pack 50 may be provided in any other device, apparatus and equipment using secondary batteries, for example, an energy storage system.

The battery pack 50 of this embodiment may be mounted in the vehicle 1 in a modularized form. For example, a plurality of battery packs 50 may be provided according to the required capacity and may be mounted in the vehicle 1 such that they are electrically connected to each other in the vehicle 1.

In this embodiment, since the pack case of the battery pack 50 is integrally formed using the potting resin as opposed to the conventional art including a plurality of plate members, it is possible to achieve the slim design of the battery pack 50 and significantly increase the energy density. Additionally, in this embodiment, it is possible to modularize the plurality of battery packs 50 in a more straightforward and convenient manner through the slim structure of the battery pack 50.

According to the various embodiments as described above, it is possible to provide the battery pack 50 with price competitiveness and reduced manufacturing cost, and the apparatus 10 and method for manufacturing a battery pack.

While a preferred embodiment of the present disclosure has been hereinabove illustrated and described, the present disclosure is not limited to the above-described particular embodiment and it is obvious to those skilled in the art that a variety of modifications and changes may be made thereto without departing from the essence of the present disclosure claimed in the appended claims, and such modifications and changes should not be individually understood from the technical aspects or scope of the present disclosure.

1. A battery pack, comprising:
a plurality of battery cells; and
a pack case in which the plurality of battery cells are accommodated,
wherein the pack case includes a potting resin covering all sides of the plurality of battery cells, the potting resin being filled to a predetermined height between the plurality of battery cells.

2. The battery pack according to claim 1, wherein the plurality of battery cells are in the potting resin with upper and lower ends of the battery cells being exposed at least in part.

3. The battery pack according to claim 1, wherein an upper surface of the potting resin is lower than an upper end of the plurality of battery cells in a heightwise direction of the plurality of battery cells, and
wherein a lower surface of the potting resin is than a lower end of the plurality of battery cells in the heightwise direction of the plurality of battery cells.

4. The battery pack according to claim 1, wherein the potting resin includes silicone resin.

5. An apparatus for manufacturing a battery pack, comprising:
a resin injection frame having an accommodation space in which a plurality of battery cells are accommodated and configured to be injected with a resin to cover the plurality of battery cells;
a resin injection port on a side of the resin injection frame and configured to inject the resin into the accommodation space; and
an air outlet spaced apart from the resin injection port, the air outlet configured to vent air inside the accommodation space to be forced out of the accommodation space through the air outlet when the resin is injected into the accommodation space.

6. The apparatus for manufacturing a battery pack according to claim 5, wherein the resin injection frame is separated from the plurality of battery cells and the cured resin when the cure of the resin injected into the accommodation space is completed.

7. The apparatus for manufacturing a battery pack according to claim 5, wherein the resin injection frame includes:
a lower frame covering a bottom of the plurality of battery cells;
an upper frame disposed opposite the lower frame to cover a top of the plurality of battery cells; and
a side frame detachably connected to the lower frame and the upper frame, wherein the side frame covers sides of the plurality of battery cells.

8. The apparatus for manufacturing a battery pack according to claim 7, wherein the resin injection port and the air outlet are disposed in the side frame.

9. The apparatus for manufacturing a battery pack according to claim 5, wherein the resin is injected in a room temperature thin state.

10. The apparatus for manufacturing a battery pack according to claim 5, wherein the resin includes a silicone resin.

11. A method for manufacturing a battery pack, comprising:
disposing a plurality of battery cells in an accommodation space of a resin injection frame;
injecting a resin for covering the plurality of battery cells into the accommodation space of the resin injection frame; and
separating the resin injection frame from the plurality of battery cells and the cured resin when the cure of the resin injected into the accommodation space is completed.

12. The method for manufacturing a battery pack according to claim 11, wherein the resin is injected into the accommodation space through a resin injection port disposed in the resin injection frame.

13. The method for manufacturing a battery pack according to claim 11, wherein the resin is injected in a room temperature thin state.

14. The method for manufacturing a battery pack according to claim 11, wherein the resin injection frame includes:
a lower frame covering a bottom of the plurality of battery cells;
an upper frame disposed opposite the lower frame to cover a top of the plurality of battery cells; and
a side frame detachably connected to the lower frame and the upper frame, wherein the side frame covers sides of the plurality of battery cells.

15. The method for manufacturing a battery pack according to claim 11, wherein the resin injection frame has an air outlet spaced apart from the resin injection port, the air outlet configured to vent air inside the accommodation space to be forced out of the accommodation space through the air outlet when the resin is injected into the accommodation space.
